(19) United States
(12) Patent Application Publication
(10) Pub. No.: US 2025/0245162 A1
(43) Pub. Date: Jul. 31, 2025

(54) MEMORY READ AHEAD FOR ARTIFICIAL INTELLIGENCE APPLICATIONS

(71) Applicant: Micron Technology, Inc., Boise, ID (US)

(72) Inventor: Luca Bert, Bologna (IT)

(21) Appl. No.: 19/035,721

(22) Filed: Jan. 23, 2025

Related U.S. Application Data
(60) Provisional application No. 63/626,848, filed on Jan. 30, 2024.

(51) Int. Cl. G06F 12/0862

(52) U.S. Cl. CPC G06F 12/0862

(57) ABSTRACT

A processing device in a memory sub-system receives, from a host system, a plurality of memory access requests associated with a plurality of processing threads executed by a plurality of processing cores on the host system, identifies the plurality of processing threads with which the plurality of memory access requests are associated, and tracks respective numbers of the plurality of memory access requests that are associated with each of the plurality processing threads in a given period of time. The processing device further selects, based on the tracking, a subset of the plurality of processing threads, prefetches data associated with the subset of the plurality of processing threads from a memory device and stores the data in a cache memory.

### RELATED APPLICATIONS

This application claims the benefit of U.S. Provisional Patent Application No. 63/626,848, filed Jan. 30, 2024, the entire contents of which are hereby incorporated by reference herein.

### TECHNICAL FIELD

Embodiments of the disclosure relate generally to memory sub-systems, and more specifically, relate to improved read ahead in a memory sub-system for artificial intelligence applications.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1 illustrates an example computing system that includes a memory sub-system in accordance with some embodiments of the present disclosure.

FIG. 2 is a block diagram illustrating a system for improved read ahead for artificial intelligence applications in accordance with some embodiments of the present disclosure.

FIG. 3 is a flow diagram of an example method of improved read ahead in a memory sub-system for artificial intelligence applications in accordance with some embodiments of the present disclosure.

FIG. 4 is a diagram illustrating access operation count tracking over a number of periods in accordance with some embodiments of the present disclosure.

FIG. 5 is a block diagram of an example computer system in which embodiments of the present disclosure may operate.

### DETAILED DESCRIPTION

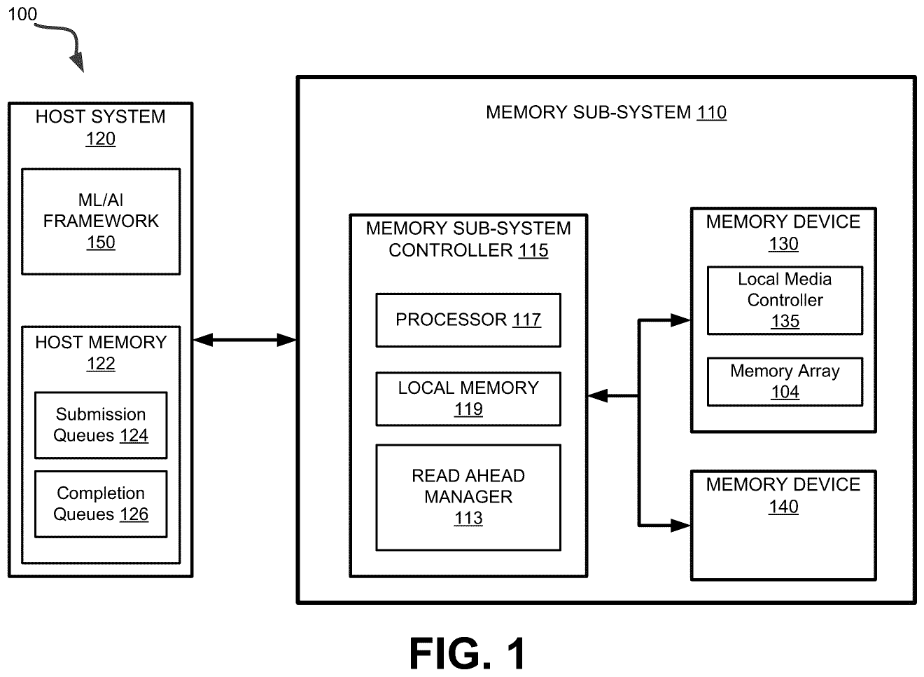

Aspects of the present disclosure are directed to improved read ahead in a memory sub- system for artificial intelligence applications. A memory sub-system can be a storage device, a memory module, or a hybrid of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. For example, NAND memory, such as 3D flash NAND memory, offers storage in the form of compact, high density configurations. A non-volatile memory device is a package of one or more dice, each including one or more planes. For some types of non-volatile memory devices (e.g., NAND memory), each plane includes of a set of physical blocks. Each block includes of a set of pages. Each page includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can be made up of bits arranged in a two-dimensional or a three-dimensional grid. Memory cells are formed onto a silicon wafer in an array of columns (also hereinafter referred to as bitlines) and rows (also hereinafter referred to as wordlines). A wordline can refer to one or more rows of memory cells of a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane.

One example of a memory sub-system is a solid-state drive (SSD) that includes one or more non-volatile memory devices and a memory sub-system controller to manage the non-volatile memory devices. In some implementations, memory sub-systems can be used to store data used to train machine learning (ML) and artificial intelligence (AI) frameworks. Certain ML/AI frameworks include a model, which is a representation of a neural network designed to receive example data as input and classify the example data into a particular type or class. In such frameworks, the amount of data used to train the ML models can be extremely large and a training process cycle can be executed multiple times (e.g., multiple “epochs”). For example, an ML framework used to classify an image as being a particular type of image (e.g., an image of a person, an animal, a type of animal, etc.) can utilize a large data set of stored images that are repeatedly processed in multiple epoch cycles to train the model. Similarly, data sets used for testing and/or inference stages of a ML/AI workflow can include very large amounts of data.

In order to process the large amounts of training data (or testing/inference data), many host systems executing ML/AI frameworks include many processing cores (e.g., central processing units, graphics processing units) which can process many threads/streams in parallel. For example, some systems could include hundreds of parallel processing threads that can processing different subsets of the training data simultaneously. As a result, each processing thread executed on a different processing core, can issue requests to read data from one or more memory sub-systems on which the training data is stored. These read requests can be characterized by a read pattern which shares certain similarities among different ML/AI frameworks. For example, the read requests are typically large in size (e.g., 128 kilobytes or larger) and are directed to sequential memory addresses within a given processing thread. A given processing thread can potentially include a large number of sequential requests (e.g., hundreds) directed to the memory sub-system, although there can be significant variance in the lengths of different streams. The computational time associated with processing the data read in any one request is relatively small, but since there are potentially hundreds of parallel processing threads, the aggregate bandwidth for the ML/AI framework is relatively high. Given the cost associated with executing the processing cores, it is imperative to eliminate downtime or missed processing cycles. The processing cores can generally process the data much faster than the data can be provided by the memory sub-system. Accordingly, any latency associated with reading the training data from the memory sub-system can be detrimental to performance of the ML/AI framework.

One approach that can be used to reduce latency is a read ahead technique where the memory sub-system can preemptively read sequential data and store it in a cache so that it can be quickly accessible if a subsequent request for that data is received. Since a majority of the latency in performing a read operation is related to accessing the requested data from the non-volatile memory device (e.g., NAND-type flash memory), by prefetching data that is expected to be requested and caching that data is a faster storage medium (e.g., DRAM or SRAM used as cache memory), the data can be provided to the ML/AI framework with much lower latency. The problem is that in a system with potentially hundreds of parallel processing threads making requests for data from the memory sub-system, and those requests being relatively large in size (e.g., 128 kilobytes or more), the limited size of the cache memory will quickly be exhausted. In fact, it is likely not possible to cache read ahead data for more than a small fraction of the total processing threads in the system. Thus, without knowing which processing threads are most likely to make repeated sequential read requests, the caching scheme is not likely to provide significant reduction in latency, as the probability that the wrong read ahead data is stored in the cache memory is high.

Aspects of the present disclosure address the above and other deficiencies by implementing improved read ahead in a memory sub-system for AI/ML applications. In one embodiment the memory sub-system implements a processing thread selection scheme to select processing threads that are more likely to provide a return in value by prefetching and caching data from sequential memory addresses associated with those threads than other processing threads executing on the host system. The processing thread selection scheme provides a selective filter, using a combination of predetermined and dynamic parameters, to identify the most active processing threads and then prefetch and cache data associated with those processing threads to optimize the use of a size-constrained cache memory in the memory sub-system. Processing logic in the memory sub-system can first identify and track received memory access requests associated with a plurality of different processing threads executed by a host system. In one embodiment, the processing logic uses a submission queue identifier (SQID) associated with each request as a proxy for identification of the corresponding processing thread. The processing logic can further filter the identified processing threads to select the most active processing threads over a rolling time window. Data associated with these most active processing threads can be prefetched from the corresponding memory device(s) and stored in a cache memory at the memory sub-system. Subsequently, if a memory access request is received for the cached data, the processing logic can provide the requested data to the host system from the cache memory.

Advantages of the approach described herein include, but are not limited to, improved performance of the memory sub-system. The processing thread selection scheme described herein associates received memory access requests with host system processing threads from which those requests are received. The scheme utilizes the likelihood of read requests from the same processing thread being directed to sequential memory addresses in order to prefetch and cache data that is most likely to be requested in the future. Identifying those processing threads for which prefetching and caching data would provide the most benefit allows for optimal use of the cache memory in the memory sub-system. When data that requested by the host system is available from the cache memory, the latency associated with providing that data to the host system is significantly reduced, which improves the quality of service. This is particularly useful when the host system is executing latency sensitive applications, such as AI/ML frameworks which often read large amounts of training data from the memory sub-system. The approaches described herein can also be applicable to other latency-sensitive implementations, including those that do not include AI/ML frameworks.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., one or more memory device(s) 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access the memory components (e.g., the one or more memory device(s) 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device(s) 130) include negative-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory device(s) 130 can include one or more arrays of memory cells. One type of memory cell, for example, single level cells (SLC) can store one bit per cell. Other types of memory cells, such as multi-level cells (MLCs), triple level cells (TLCs), and quad-level cells (QLCs), can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, or a QLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, electrically erasable programmable read-only memory (EEPROM).

A memory sub-system controller 115 (or controller 115 for simplicity) can communicate with the memory device(s) 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device(s) 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory device(s) 130. The memory sub-system controller 115 can further include host interface circuitry to communicate with the host system 120 via the physical host interface. The host interface circuitry can convert the commands received from the host system into command instructions to access the memory device(s) 130 as well as convert responses associated with the memory device(s) 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory device(s) 130.

In some embodiments, the memory device(s) 130 include local media controllers 135 that operate in conjunction with memory sub-system controller 115 to execute operations on one or more memory cells of the memory device(s) 130. An external controller (e.g., memory sub-system controller 115) can externally manage the memory device 130 (e.g., perform media management operations on the memory device(s) 130). In some embodiments, a memory device 130 is a managed memory device, which is a raw memory device (e.g., memory array 104) having control logic (e.g., local controller 135) for media management within the same memory device package. An example of a managed memory device is a managed NAND (MNAND) device. Memory device(s) 130, for example, can each represent a single die having some control logic (e.g., local media controller 135) embodied thereon. In some embodiments, one or more components of memory sub-system 110 can be omitted.

In one embodiment, the host system 120 includes ML/AI framework 150. ML/AI framework 150 can include one or more ML models, a processing engine, and a training engine, among other components, which can be used to perform any automated task (e.g., classify or categorize documents or images). In order to train the one or more ML models, ML/AI framework 150 can issue requests to read the training data, which may be stored on memory device 130 of memory sub-system 110, and process the training data accordingly. In one embodiment, ML/AI framework 150 is executed by multiple processing cores (e.g., central processing units, graphics processing units) which can process many threads/streams in parallel. For example, host system 120 could include hundreds of parallel processing threads that can request and process different subsets of the training data concurrently. In one embodiment, the host system 120 utilizes a set of queues to track the memory access commands issued to the memory sub-system 110 (e.g., requests to read training data for ML/AI framework 150). For example, the host system 120 can include a number of submission queues 124, storing submission queue entries representing the memory access commands issued to the memory sub-system 110, and a number of completion queues 126, storing completion queue entries received from the memory sub-system 110 to indicate that the corresponding memory access commands have been executed. In one embodiment, the host system 120 can maintain these queues in a host memory 122, such as a dynamic random access memory (DRAM) device or other memory device. Submission queues 124 and completion queues 126 can include circular buffers with a fixed slot size. In other embodiments, there can be some other number of queues or queue pairs in host memory 122.

In one embodiment, memory sub-system 110 includes read ahead manager 113. In some embodiments, the memory sub-system controller 115 includes at least a portion of the read ahead manager 113. For example, the memory sub-system controller 115 can include a processor 117 (processing device) configured to execute instructions stored in local memory 119 for performing the operations described herein. In one embodiment, read ahead manager 113 implements a processing thread selection scheme to select processing threads executing ML/AI framework 150 that are more likely to provide a return in value by prefetching and caching data from sequential memory addresses associated with those threads than other processing threads executing on the host system. Read ahead manager 113 can select the most active processing threads over a rolling time window and prefetch data associated with those processing threads from memory device 130 and store the data in a cache memory (e.g., implemented in local memory 119) at the memory sub-system 110. Subsequently, if a memory access request is received from ML/AI framework 150 for the cached data, read ahead manager 113 can provide the requested data from the cache memory. Further details with regard to the operations of read ahead manager 113 are described below.

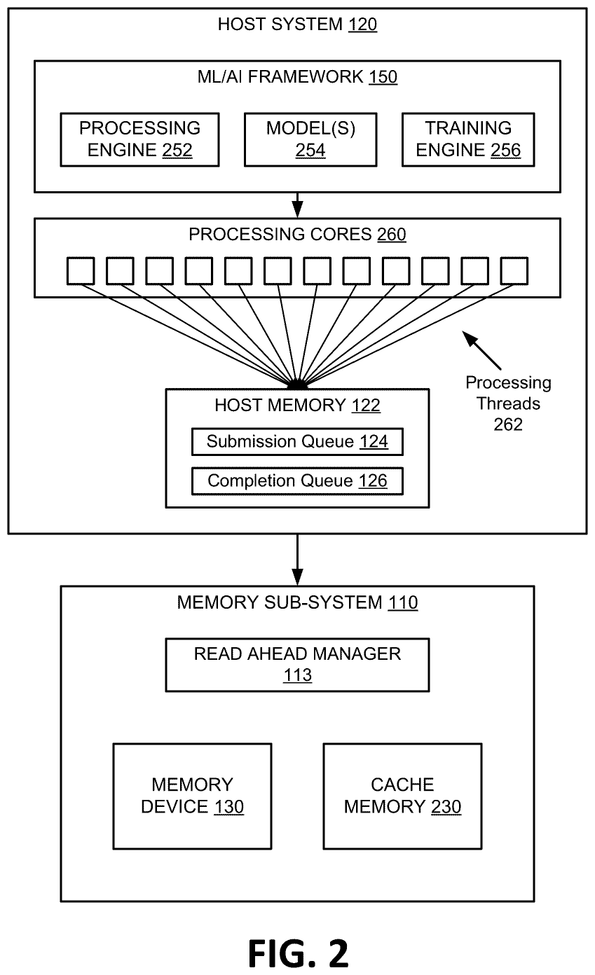

FIG. 2 is a block diagram illustrating a system for improved read ahead for artificial intelligence applications in accordance with some embodiments of the present disclosure. As illustrated, host system 120 includes ML/AI framework 150 which can be executed by a number of processing cores 260. Host system 120 further includes host memory 122, including submission queues 124 and completion queues 126. In one embodiment, ML/AI framework 150 includes a processing engine 252, one or more machine learning models, 254, and a training engine 256, among other components, which can be used to perform any automated task (e.g., classify or categorize documents or images). Depending on the implementation one or more components that make up ML/AI framework 150 can be distributed across multiple different computing devices (e.g., host computers, servers, etc.). In one embodiment, processing engine 252 may use a set of trained machine learning models 254 that are trained and used to perform any number of automated operations. The processing engine 252 may also preprocess any received input data prior to using the data for training of the set of machine learning models 254 and/or applying the set of trained machine learning models 254 to the input data. Based on the output of the set of trained machine learning models 254, the processing engine 252 may obtain, for example, a classification and/or category of the input data, as well an assessment of the classification.

The set of machine learning models 254 may refer to model artifacts that are created by the training engine 256 using training data that includes training inputs and corresponding target outputs (i.e., correct answers for respective training inputs). During training, patterns in the training data that map the training input to the target output (i.e., the answer to be predicted) can be found, and are subsequently used by the machine learning models 254 for future predictions. Depending on the implementation, the set of machine learning models 254 may be composed of, for example, a single level of linear or non-linear operations (e.g., a support vector machine [SVM]) or may be a deep network, (i.e., a machine learning model that is composed of multiple levels of non-linear operations). Examples of deep networks are neural networks including convolutional neural networks, recurrent neural networks with one or more hidden layers, and fully connected neural networks.

Thus, in order to train the one or more machine learning models 254, ML/AI framework 150 can issue requests to read the training data, which may be stored on memory device 130 of memory sub-system 110, and process the training data accordingly. In one embodiment, these memory access requests are sent by the parallel processing threads 262 being executed by processing cores 260. Processing cores 260 can include a number of general-purpose processing devices such as microprocessors, central processing units (CPUs), or the like, or more specialized processing devices, such as graphics processing units (GPUs), which may be optimized for performing high-speed sequential processing operations. Depending on the implementation there can be any number of processing cores 260 (e.g., tens or hundreds), each executing a respective one of processing threads 262. Each processing thread 262 represents a series of sequential operations directed to memory sub-system 110 (e.g., read requests for separate segments of an element of training data stored at memory sub-system 110). Due to the large relative size of the training data, each element may be broken up into separate segments of a smaller fixed size and stored at sequential memory addresses in memory sub-system 110. Thus, in order to read the entire element of training data, a sequence of multiple read requests can be issued to obtain all of the separate segments. Each processing thread 262 can include a series of read requests to read the segments of a different element of training data from memory sub-system 110. Upon the read requests from each processing thread 262 being generated, the requests can be stored as entries in one of submission queues 124, from which they can be issued to memory sub-system 110. Received responses to the requests from memory sub-system 110 can be stored as entries in one of completion queues 126, retrieved by processing threads 262 and provided to ML/AI framework 150 for execution in either a training phase or an inference phase.

Read ahead manager 113 of memory sub-system 110 can receive the memory access requests from submission queues 124 and retrieve the requested data. If the requested data is already available in cache memory 230, read ahead manager 113 can retrieve the data from cache memory 230 and provide it to host system 120 in response to the request. If the requested data is not available in cache memory 230, read ahead manager 113 can retrieve the data from memory device 130 and provide it to host system 120 in response to the request. As will be described in more detail below, read ahead manager 113 can implement a processing thread selection scheme to identify processing threads 262 that are more likely to provide a return in value by prefetching and caching data from sequential memory addresses associated with those threads than other processing threads executing on the host system 120. The processing thread selection scheme provides a selective filter, using a combination of predetermined and dynamic parameters, to identify the most active processing threads 262 and then prefetch and cache data associated with those processing threads in cache memory 230. Read ahead manager 113 can first identify and track received memory access requests associated with a plurality of different processing threads 262 (e.g., by using a submission queue identifier (SQID) associated with each request as a proxy for identification of the corresponding processing thread), and can further filter the identified processing threads to select the most active processing threads over a rolling time window. Data associated with these most active processing threads can be prefetched from the corresponding memory device 130 and stored in the cache memory 230.

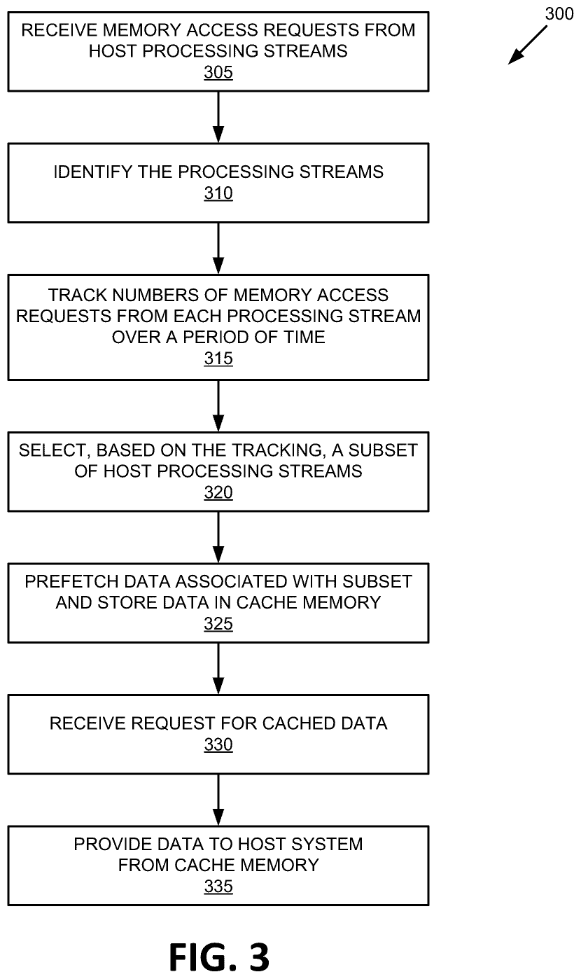

FIG. 3 is a flow diagram of an example method of improved read ahead in a memory sub-system for artificial intelligence applications in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the read ahead manager 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 305, the processing logic (e.g., read ahead manager 113) receives, from a host system, such as host system 120, a plurality of memory access requests associated with a plurality of processing threads 262 executed by a plurality of processing cores 260 on the host system. In one embodiment, the plurality of memory access requests comprise requests to read training data from a memory device 130 of memory sub-system 110, for at least one of a machine learning (ML) model or an artificial intelligence (AI) framework (e.g., ML/AL framework 150, machine learning model 254).

At operation 310, the processing logic identifies the plurality of processing threads 262 with which the plurality of memory access requests are associated. In one embodiment, each of the plurality of processing threads 262 is executed by a respective one of the plurality of processing cores 260 and comprises a plurality of sequential memory access requests. For example each thread can include a series of requests for different segments of a piece of training data stored at memory sub-system 110, where each of the different segments are stored at sequential memory addresses. In one embodiment, the processing logic uses a submission queue identifier (SQID) associated with each request as a proxy for identification of the corresponding processing thread. Although a direct identifier of the processing thread from which a request is sent is not received with the request, an indication of the submission queue from which the request is sent is received. Since each processing thread is likely to include a relatively large number of requests (e.g., tens or hundreds of requests), and all requests from the same processing thread are sent via the same submission queue 124, the processing logic can use the submission queue identifier as a proxy for identification of the corresponding processing thread with a relatively high degree of confidence.

At operation 315, the processing logic tracks respective numbers of the plurality of memory access requests that are associated with each of the plurality processing threads in a given period of time. In one embodiment, read ahead manager 113 maintains a number of counters corresponding to the submission queue identifiers (SQIDs) and can increment the respective counters when requests from the corresponding SQIDs are received. In one embodiment, the respective counters are incremented only when certain conditions are satisfied. For example, rather than considering all memory access operations, the read ahead manager 113 may only increment a counter when a read request is received from the corresponding SQID (i.e., excluding write requests and other commands). In addition, the read ahead manager 113 may implement a size threshold when tracking the received memory access requests. For example, the read ahead manager 113 may only increment a counter when a read request for data that is greater than or equal to the threshold (e.g., 16 kilobytes) is received from the corresponding SQID (i.e., excluding smaller read requests). As the respective counters are incremented, the result is ranked list (e.g., implemented as an array) of the SQIDs based on how many memory access requests have been received within the period of time.

At operation 320, the processing logic selects, based on the tracking, a subset of the plurality of processing threads. In one embodiment, the read ahead manager 113 selects a number of processing threads that have issued the highest number of memory access requests in the given period of time. In order to accomplish this, the read ahead manager can perform a trimming of the list to represent a finite period of time and not all of time. This can prevent the counters from being incremented to extremely large numbers and helps to filter out SQIDs that were active previously, and thus have larger counter values, but have not been active more recently. The definite period of time can be a tunable parameter that can vary depending on the specific implementation. In one embodiment, the period of time can be one second, which is a period of time large enough to collect enough data to be significant and short enough to account for dynamic transitions. At the end of the period, the read ahead manager 113 can sort the list based on respective count values and identify a threshold number of SQIDs that have the highest number of tracked memory access requests. The threshold number is also a configurable parameter and can be set based on the size of the cache memory 230 in the memory sub-system 110.

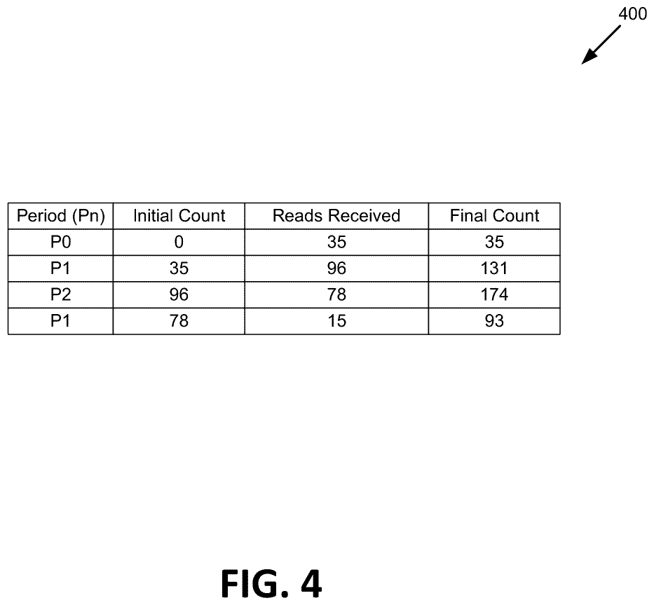

In one embodiment, the read ahead manager 113 retains some history in the ranked list from one period of time to the next. The history from the previous period can be relevant in determining which SQIDs would be good candidates for performing a read ahead operation and, therefore, the read ahead manager 113 can refrain from simply resetting the counters and starting from scratch at the beginning of each new period. FIG. 4 is a diagram illustrating access operation count tracking over a number of periods in accordance with some embodiments of the present disclosure. The table 400 represents count tracking for a single SQID and includes columns representing a given period of time, an initial count value for the period, the number of reads received in that period, a final count value for the period. Beginning with period P0, the initial count value is 0, and 35 read operations are received during the period, so the final count value is 35. For each subsequent period, the counter can be set to an initial count value that represents the number of read operations received during the previous period. This can also be represented as the final value from the previous period minus initial value from the previous period. Thus, for the next period P1, the initial count value is set to 35 (i.e., 35-0), and 96 read operations are received during the period, so the final count value is 131. For period P2, the initial count value is set to 96 (i.e., 131-35), and 78 read operations are received during the period, so the final count value is 174. For period P3, the initial count value is set to 78 (i.e., 174-96), and 15 read operations are received during the period, so the final count value is 93. In this manner, the history of the SQID from period to period is maintained, and can be used to provide a valid ranking at the beginning of the next period, while waiting for new history to build up. The result is a list that tracks only the most promising data reads (i.e., no writes, large size), is ranked from more intensive (i.e., more IOs) to less intensive, each SQID count most likely represents read requests from the same processing thread 262, and is periodically refreshed to track dynamic variation without losing history. The size of the list may be large (e.g., hundreds or thousands of SQIDs) so it cannot entirely be used for read caching. If the read ahead manager 113 determines that the read ahead segment size should be of a specific size (e.g., 128 kilobytes), and that there is room in the cache memory 230 to cache K read ahead segments, the top K SQIDs in the list can be selected.

Referring again to FIG. 3, at operation 325, the processing logic prefetches data associated with the subset of the plurality of processing threads from the memory device and stores the data in the cache memory. In one embodiment, to prefetch the data, the read ahead manager 113 can retrieve data at a sequential memory address from memory device 130 and store the data in cache memory 230 before a request for the data is even received. For example, subsequent to receiving a request for data at a first memory address in the memory device 130, the read ahead manager 113 can retrieve data at a second memory address in the memory device 130, sequential to the first memory address, prior to receiving a request for the data at the second memory address and store the data at the second memory address in the cache memory 230. Given the likelihood that subsequent requests received from the same SQID are from the same processing thread 262 as the previous requests, it is likely that the subsequent requests will be for additional segments of an element of training data stored on memory device 130 at sequential memory addresses. Thus, for the most active SQIDs, as determined at operation 320, the read ahead manager can read ahead additional data.

At operation 330, the processing logic receives, from the host system 120, a memory access request for the data at the second memory address. The read ahead manager 113 can determine whether the requested data is present in the cache memory 230. At operation 335, the processing logic provides the data at the second memory address to the host system 120 from the cache memory 230. In one embodiment, the host system 120 can increment the respective counter for the SQID from which the request was received even though the requested data was already present in the cache memory 230.

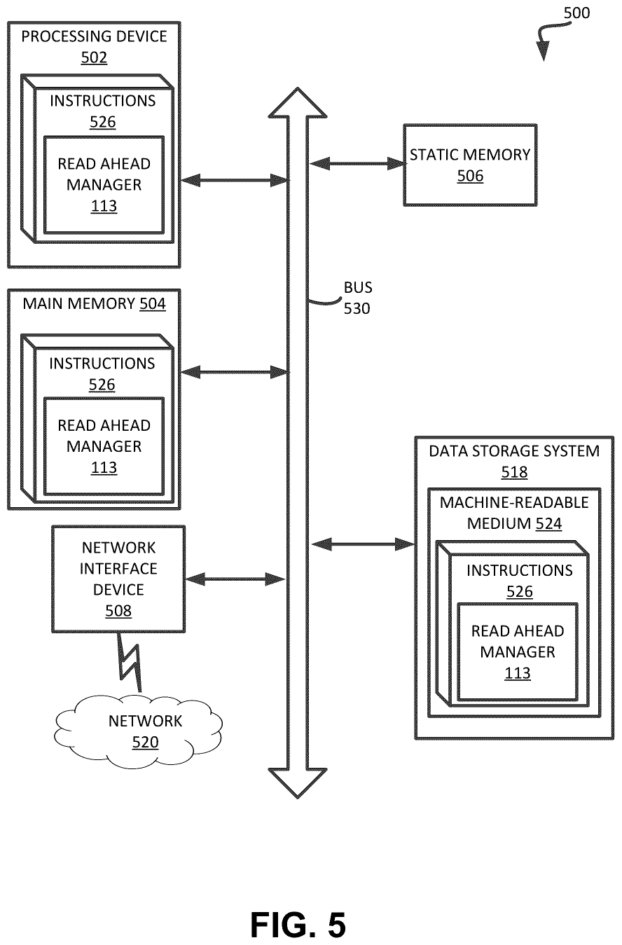

FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the read ahead manager 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1.

In one embodiment, the instructions 526 include instructions to implement functionality corresponding to the read ahead manager 113 of FIG. 1). While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device;
a cache memory; and
a processing device, operatively coupled with the memory device and the cache memory, to perform operations comprising:
receiving, from a host system, a plurality of memory access requests associated with a plurality of processing threads executed by a plurality of processing cores on the host system;
identifying the plurality of processing threads with which the plurality of memory access requests are associated;
tracking respective numbers of the plurality of memory access requests that are associated with each of the plurality processing threads in a given period of time;
selecting, based on the tracking, a subset of the plurality of processing threads; and
prefetching data associated with the subset of the plurality of processing threads from the memory device and storing the data in the cache memory.

2. The system of claim 1, wherein the plurality of memory access requests comprise requests to read training data from the memory device for at least one of a machine learning (ML) model or an artificial intelligence (AI) framework.

3. The system of claim 1, wherein each of the plurality of processing threads is executed by a respective one of the plurality of processing cores and comprises a plurality of sequential memory access requests.

4. The system of claim 1, wherein tracking the respective numbers of the plurality of memory requests that are associated with each of the plurality processing threads in a given period of time comprises:
determining respective submission queue identifiers (SQIDs) for the plurality of memory requests; and
incrementing respective counters associated with the respective SQIDs, wherein the counters are periodically decremented based on the given period of time.

5. The system of claim 1, wherein selecting the subset of the plurality of processing threads comprises selecting a number of processing threads that have issued the highest number of memory access requests in the given period of time.

6. The system of claim 1, wherein prefetching the data associated with the subset of the plurality of processing threads from the memory device and storing the data in the cache memory comprises:
subsequent to receiving a request for data at a first memory address in the memory device, retrieving data at a second memory address in the memory device prior to receiving a request for the data at the second memory address and storing the data at the second memory address in the cache memory, wherein the second memory address is sequential to the first memory address.

7. The system of claim 6 wherein the processing device is to perform operations further comprising:
receiving, from the host system, a memory access request for the data at the second memory address; and
providing the data at the second memory address to the host system from the cache memory.

8. A method comprising:
receiving, from a host system, a plurality of memory access requests associated with a plurality of processing threads executed by a plurality of processing cores on the host system;
identifying the plurality of processing threads with which the plurality of memory access requests are associated;
tracking respective numbers of the plurality of memory access requests that are associated with each of the plurality processing threads in a given period of time;
selecting, based on the tracking, a subset of the plurality of processing threads; and
prefetching data associated with the subset of the plurality of processing threads from a memory device and storing the data in a cache memory.

9. The method of claim 8, wherein the plurality of memory access requests comprise requests to read training data from the memory device for at least one of a machine learning (ML) model or an artificial intelligence (AI) framework.

10. The method of claim 8, wherein each of the plurality of processing threads is executed by a respective one of the plurality of processing cores and comprises a plurality of sequential memory access requests.

11. The method of claim 8, wherein tracking the respective numbers of the plurality of memory requests that are associated with each of the plurality processing threads in a given period of time comprises:
determining respective submission queue identifiers (SQIDs) for the plurality of memory requests; and
incrementing respective counters associated with the respective SQIDs, wherein the counters are periodically decremented based on the given period of time.

12. The method of claim 8, wherein selecting the subset of the plurality of processing threads comprises selecting a number of processing threads that have issued the highest number of memory access requests in the given period of time.

13. The method of claim 8, wherein prefetching the data associated with the subset of the plurality of processing threads from the memory device and storing the data in the cache memory comprises:
subsequent to receiving a request for data at a first memory address in the memory device, retrieving data at a second memory address in the memory device prior to receiving a request for the data at the second memory address and storing the data at the second memory address in the cache memory, wherein the second memory address is sequential to the first memory address.

14. The method of claim 13, further comprising:
receiving, from the host system, a memory access request for the data at the second memory address; and
providing the data at the second memory address to the host system from the cache memory.

15. A non-transitory computer-readable storage medium comprising instructions that, when executed by a processing device, cause the processing device to perform operations comprising:
receiving, from a host system, a plurality of memory access requests associated with a plurality of processing threads executed by a plurality of processing cores on the host system;
identifying the plurality of processing threads with which the plurality of memory access requests are associated;
tracking respective numbers of the plurality of memory access requests that are associated with each of the plurality processing threads in a given period of time;
selecting, based on the tracking, a subset of the plurality of processing threads; and
prefetching data associated with the subset of the plurality of processing threads from a memory device and storing the data in a cache memory.

16. The non-transitory computer-readable storage medium of claim 15, wherein the plurality of memory access requests comprise requests to read training data from the memory device for at least one of a machine learning (ML) model or an artificial intelligence (AI) framework.

17. The non-transitory computer-readable storage medium of claim 15, wherein each of the plurality of processing threads is executed by a respective one of the plurality of processing cores and comprises a plurality of sequential memory access requests.

18. The non-transitory computer-readable storage medium of claim 15, wherein tracking the respective numbers of the plurality of memory requests that are associated with each of the plurality processing threads in a given period of time comprises:
determining respective submission queue identifiers (SQIDs) for the plurality of memory requests; and
incrementing respective counters associated with the respective SQIDs, wherein the counters are periodically decremented based on the given period of time.

19. The non-transitory computer-readable storage medium of claim 15, wherein selecting the subset of the plurality of processing threads comprises selecting a number of processing threads that have issued the highest number of memory access requests in the given period of time.

20. The non-transitory computer-readable storage medium of claim 15, wherein prefetching the data associated with the subset of the plurality of processing threads from the memory device and storing the data in the cache memory comprises:
subsequent to receiving a request for data at a first memory address in the memory device, retrieving data at a second memory address in the memory device prior to receiving a request for the data at the second memory address and storing the data at the second memory address in the cache memory, wherein the second memory address is sequential to the first memory address.
